(19) United States
(12) Patent Application Publication
(10) Pub. No.: US 2011/0134316 A1
(43) Pub. Date: Jun. 9, 2011

(54) IMAGE DISPLAY APPARATUS AND METHOD

(75) Inventors: Takahiro Oguchi, Sagamihara-shi (JP); Nobuhiro Hoshi, Yokohama-shi (JP)

(73) Assignee: CANON KABUSHIKI KAISHA, Tokyo (JP)

(21) Appl. No.: 12/950,138

(22) Filed: Nov. 19, 2010

(30) Foreign Application Priority Data
Dec. 8, 2009 (JP) 2009-278947

(51) Int. Cl. H04N 7/01

(52) U.S. Cl. 348/441; 348/E07.003

(57) ABSTRACT

The image signal of each pixel of a frame image is multiplied by a gain value set in advance for each coordinate position on a display screen, generating a display frame image in which the luminance value becomes smaller for a pixel closer to the periphery of the display screen and larger for a pixel closer to the center. The image signal of each pixel of a subframe image is multiplied by a gain value set in advance for each coordinate position on the display screen, generating a display subframe image in which the luminance value becomes larger for a pixel closer to the periphery of the display screen and smaller for a pixel closer to the center of the display screen. The display frame image and display subframe image are sequentially displayed.

### BACKGROUND OF THE INVENTION

1. Field of the Invention

The present invention relates to a moving image display technique.

2. Description of the Related Art

Recently, a liquid crystal display (to be referred to as an LCD) and the like are receiving attention as flat-panel displays. The LCD adopts a driving method called hold driving which keeps the display luminance constant in one frame period. On the LCD, an image looks blurred in a moving image display, like television broadcasting.

In contrast, a display apparatus using a cathode ray tube or FED (Field Emission Display) employs a driving method called impulse driving, which emits strong light instantaneously in a short time. A display apparatus of this type is free from the problem in which a moving image looks blurred.

In general, as the black display period in the display period becomes longer, the display comes closer to impulse display, improving the problem in which an image looks blurred. To improve this problem, Japanese Patent Laid-Open No. 2006-343706 discloses the following LCD. More specifically, one frame image is divided into two subframe images. One subframe image is displayed at high luminance while the other is displayed at low luminance, improving the problem in which an image looks blurred.

Also in a projector apparatus using an LCD, the problem in which an image looks blurred is improved by alternately outputting an original image and a subframe image obtained by performing LPF (Low-Pass Filter) processing for the original image, as described in Japanese Patent Laid-Open No. 2006-184896.

Japanese Patent Laid-Open No. 2008-70838 discloses a method of generating a plurality of frame images from an input image signal by interpolation processing, and displaying them at double speed, thereby improving the problem in which an image looks blurred. Although the NTSC broadcasting system in Japan and US has a frame rate of about 60 Hz, a double-speed driving LCD television displays an image at a frame rate of 120 Hz or 240 Hz and has already been commercialized.

On the display apparatus that adopts impulse driving using a cathode ray tube or FED, an image does not look blurred, but the screen flickers more and more (flickering) for a larger screen display. To prevent flickering, the display using cathode ray tube or FED sometimes employs a double-speed driving method to divide one frame image into a plurality of subframe images and display them.

To prevent flickering, the impulse driving display apparatus sometimes employs the double-speed driving method to divide an input frame image into a double number of subframe images and display them. The use of double-speed driving poses the following problem.

That is, an interpolated frame image generated for double-speed display is a new image generated by predicting the motion of a moving object. According to the circumstances, a correct interpolated frame image is not always generated. Depending on an input frame image, an erroneously interpolated frame image may be generated. When the user views the erroneously generated interpolated frame image, degradation of the image quality may stand out.

As a method of reducing degradation of the image quality caused by an interpolated frame image, the luminance of an interpolated frame image generated by interpolation is decreased in some cases. However, decreasing the luminance of an interpolated frame image increases flickering. Thus, degradation of the image quality and reduction of flickering have a tradeoff relationship. Especially on a large-screen display apparatus, the luminance difference at the periphery of the screen is sensed as large flickering and becomes a serious problem.

### SUMMARY OF THE INVENTION

The present invention has been made to solve the above problems, and provides a technique for displaying a higher-quality moving image even when double-speed display is performed.

According to the first aspect of the present invention, an image display apparatus, comprises: an input unit which sequentially inputs frame images that form a moving image; a subframe image generation unit which generates a subframe image to be displayed at timing between display timings of two adjacent frame images; a display frame image generation unit which generates a display frame image, in which a pixel being at a pixel position closer to a periphery of the frame image has smaller luminance value than that of a pixel being at a center of the frame image; a display subframe image generation unit which generates a display subframe image, in which a pixel being at a pixel position closer to a periphery of the frame image has larger luminance value than that of a pixel being at a center of the frame image; and an output unit which sequentially outputs the display frame image and the display subframe image.

According to the second aspect of the present invention, an image display method performed by an image display apparatus having a display screen for displaying a moving image, comprises: an input step of sequentially inputting frame images that form the moving image; a subframe image generation step of generating a subframe image to be displayed at timing between display timings of two adjacent frame images; a display frame image generation step of generating a display frame image, in which a pixel being at a pixel position closer to a periphery of the frame image has smaller luminance value than that of a pixel being at a center of the frame image; a display subframe image generation step of generating a display subframe image, in which a pixel being at a pixel position closer to a periphery of the frame image has larger luminance value than that of a pixel being at a center of the frame image; and an output step of sequentially outputting the display frame image and the display subframe image.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram exemplifying the functional arrangement of an image display apparatus according to the first embodiment;

FIGS. 2A to 2D are views for explaining a gain value;

FIGS. 3A to 3C are views for explaining the luminance distributions of frame and subframe images;

FIG. 4 is a graph for explaining the luminance distributions of frame and subframe images; and

FIG. 5 is a flowchart of processing performed by the image display apparatus.

### DESCRIPTION OF THE EMBODIMENTS

Embodiments of the present invention will now be described with reference to the accompanying drawings. It should be noted that the following embodiments are merely examples of specifically practicing the present invention, and are practical examples of the arrangement defined by the scope of the appended claims.

### First Embodiment

The first embodiment will describe an image display apparatus that displays a moving image complying with the HDTV broadcasting system (1,920 horizontal pixels×1,080 vertical pixels) in Japan and US. However, as will be apparent from the following description, the gist of the following description is not limited to display of a moving image of this system, and is also applicable to display of a moving image of another system.

In the first embodiment, a frame image and a subframe image generated from the frame image are alternately displayed on the display screen. At this time, the frame image is displayed by setting the luminance value to be higher for a pixel closer to the center of the display screen and lower for a pixel closer to the periphery of the display screen. The subframe image is displayed by setting the luminance value to be lower for a pixel closer to the center of the display screen and higher for a pixel closer to the periphery of the display screen. That is, the luminance value difference between the frame and subframe images at the center of the display screen is set larger than that at the periphery.

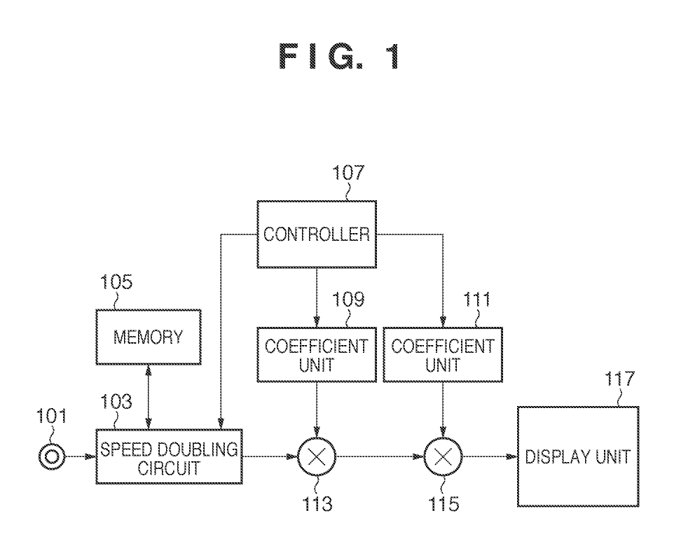

The first embodiment will be explained in more detail. First, an image display apparatus according to the embodiment will be described with reference to the block diagram of FIG. 1. The images of respective frames (frame images), which form a moving image, are sequentially input to an input terminal 101. A subsequent speed doubling circuit 103 receives each input frame image.

The speed doubling circuit 103 increases the frame rate of a frame image input via the input terminal 101. A method of increasing the frame rate is, for example, motion compensation. In the motion compensation method, a motion vector is calculated using two adjacent frame images. By using the calculated motion vector, a subframe image to be displayed at timing between the display timings of the two adjacent frame images is calculated. Then, the frame and subframe images are alternately displayed. For example, the speed doubling circuit 103 increases the rate of an input frame image (image signal) compliant with the NTSC or HDTV broadcasting system in Japan and US from 60 Hz to 120 Hz. The speed doubling circuit 103 increases the rate of an input frame image (image signal) of 60 Hz to 100 Hz in the PAL broadcasting system in Europe. Note that the method of calculating a subframe image to be displayed at timing between the display timings of two adjacent frame images is not limited to the above method. For example, a subframe image may be calculated using two or more adjacent frame images.

When increasing the frame rate by the speed doubling circuit 103 according to the motion compensation method, the speed doubling circuit 103 first stores a frame image f of the fth frame input from the input terminal 101 in a memory 105. The speed doubling circuit 103 obtains a motion vector using the input frame image f and a frame image (f−1) of the (f−1)th frame that has already been stored in the memory 105. By using the obtained motion vector, the speed doubling circuit 103 generates a subframe image g to be displayed at timing between the display timings of the frame image f and frame image (f−1). The processing executed by the speed doubling circuit 103 is a well-known technique, and a more detailed description thereof will be omitted. Processing performed by the speed doubling circuit 103 is not limited to this as long as a similar subframe image can be generated.

The speed doubling circuit 103 sequentially sends the frame image f and generated subframe image g to a subsequent multiplier 113. Note that a controller 107 controls the operation of the speed doubling circuit 103. The controller 107 controls the operation of the speed doubling circuit 103 by sending a control signal to the speed doubling circuit 103.

Upon receiving the frame image f from the speed doubling circuit 103, the multiplier 113 multiplies the image signal of each pixel on a horizontal line by a gain value (coefficient value) supplied from a coefficient unit 109 for this pixel in order to adjust the horizontal luminance value of the frame image f. The multiplier 113 sends, to a subsequent multiplier 115, a frame image f′ obtained by multiplying each horizontal line by the gain value.

Upon receiving the subframe image g from the speed doubling circuit 103, the multiplier 113 executes the following processing to adjust the horizontal luminance value of the subframe image g. More specifically, the multiplier 113 multiplies the image signal of each pixel on a horizontal line by a gain value supplied from the coefficient unit 109 for this pixel. The multiplier 113 sends, to the subsequent multiplier 115, a subframe image g′ obtained by multiplying each horizontal line by the gain value.

Upon receiving the frame image f′ from the multiplier 113, the multiplier 115 performs the following processing to adjust the vertical luminance value of the frame image f′. More specifically, the multiplier 115 multiplies the image signal of each pixel on a vertical line by a gain value supplied from a coefficient unit 111 for this pixel. The multiplier 115 sends, as a display frame image to a subsequent display unit 117, a frame image f″ obtained by multiplying each vertical line by the gain value (first generation).

Upon receiving the subframe image g′ from the multiplier 113, the multiplier 115 executes the following processing to adjust the vertical luminance value of the subframe image g′. More specifically, the multiplier 115 multiplies the image signal of each pixel on a vertical line by a gain value supplied from the coefficient unit 111 for this pixel. The multiplier 115 sends, as a display subframe image to the subsequent display unit 117, a subframe image g″ obtained by multiplying each vertical line by the gain value (second generation).

As a result, the display unit 117 sequentially displays the frame image f″ and subframe image g″. Note that the display unit 117 suffices to be an impulse driving display apparatus capable of double-speed display. The display unit 117 may be, for example, a cathode ray tube, organic EL display, or FED.

When the frame image f is output to the speed doubling circuit 103, the controller 107 notifies the coefficient units 109 and 111 that the frame image f has been output. Further, the controller 107 notifies the coefficient units 109 and 111 of the horizontal position of a pixel (horizontal pixel position) to be multiplied by a gain value in the frame image f, and the vertical position of the pixel (vertical pixel position) to be multiplied by a gain value in the frame image f, respectively.

When the subframe image g is output to the speed doubling circuit 103, the controller 107 notifies the coefficient units 109 and 111 that the subframe image g has been output. In addition, the controller 107 notifies the coefficient units 109 and 111 of the horizontal position of a pixel (horizontal pixel position) to be multiplied by a gain value in the subframe image g, and the vertical position of the pixel (vertical pixel position) to be multiplied by a gain value in the subframe image g, respectively.

The coefficient unit 109 stores a frame image gain value which is set (assigned) in advance for each horizontal position on the display screen of the display unit 117, and a subframe image gain value which is set (assigned) in advance for each horizontal position on the display screen of the display unit 117. Upon receiving, from the controller 107, the notification that the frame image f has been output, and the horizontal position of a pixel to be multiplied by a gain value in the frame image f, the coefficient unit 109 supplies, to the multiplier 113, a frame image gain value corresponding to the horizontal position designated by the controller 107. Also, upon receiving, from the controller 107, the notification that the subframe image g has been output, and the horizontal position of a pixel to be multiplied by a gain value in the subframe image g, the coefficient unit 109 supplies, to the multiplier 113, a subframe image gain value corresponding to the horizontal position designated by the controller 107.

The coefficient unit 111 stores a frame image gain value which is set (assigned) in advance for each vertical position on the display screen of the display unit 117, and a subframe image gain value which is set (assigned) in advance for each vertical position on the display screen of the display unit 117. Upon receiving, from the controller 107, the notification that the frame image f has been output, and the vertical position of a pixel to be multiplied by a gain value in the frame image f, the coefficient unit 111 supplies, to the multiplier 115, a frame image gain value corresponding to the vertical position designated by the controller 107. Also, upon receiving, from the controller 107, the notification that the subframe image g has been output, and the vertical position of a pixel to be multiplied by a gain value in the subframe image g, the coefficient unit 111 supplies, to the multiplier 115, a subframe image gain value corresponding to the vertical position designated by the controller 107.

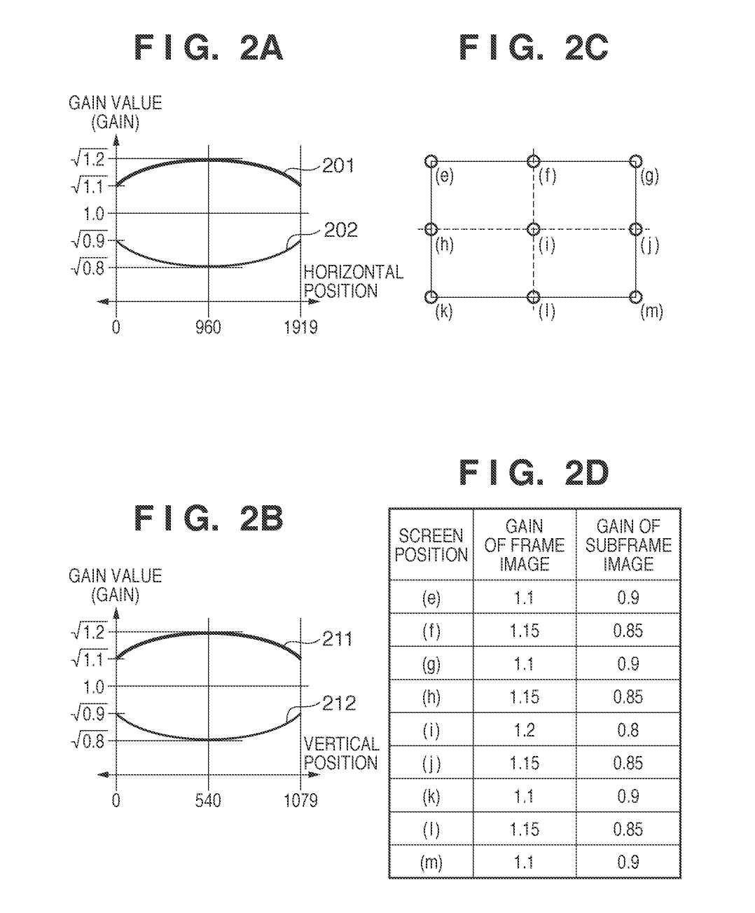

Gain values stored in the coefficient unit 109 have a distribution as shown in FIG. 2A. In FIG. 2A, the abscissa axis indicates a horizontal position in the display screen of the display unit 117, and the ordinate axis indicates a gain value (gain).

In a frame image gain value distribution 201, the gain value becomes smaller for a horizontal position closer to the right or left end of the display screen of the display unit 117. The gain value becomes larger for a horizontal position closer to the center of the display screen of the display unit 117. In FIG. 2A, the gain value for a horizontal position at the center of the display screen of the display unit 117 is √1.2. As the horizontal position comes close to the right or left end of the display screen of the display unit 117, the gain value decreases and becomes √1.1 at a horizontal position at the right or left end.

In a subframe image gain value distribution 202, the gain value becomes larger for a horizontal position closer to the right or left end of the display screen of the display unit 117. The gain value becomes smaller for a horizontal position closer to the center of the display screen of the display unit 117. In FIG. 2A, the gain value for a horizontal position at the center of the display screen of the display unit 117 is √0.8. As the horizontal position comes close to the right or left end of the display screen of the display unit 117, the gain value increases and becomes √0.9 at a horizontal position at the right or left end. For an HDTV broadcast signal, the number of horizontal pixels is 1,920, so the coefficient unit 109 holds 1,920 gain values×two frames=3,840 gain values. At all horizontal positions, the sum of the frame image gain value and subframe image gain value is always constant (=1.0).

In contrast, gain values stored in the coefficient unit 111 have a distribution as shown in FIG. 2B. In FIG. 2B, the abscissa axis indicates a vertical position in the display screen of the display unit 117, and the ordinate axis indicates a gain value (gain).

In a frame image gain value distribution 211, the gain value becomes smaller for a vertical position closer to the upper or lower end of the display screen of the display unit 117. The gain value becomes larger for a vertical position closer to the center of the display screen of the display unit 117. In FIG. 2B, the gain value for a vertical position at the center of the display screen of the display unit 117 is √1.2. As the vertical position comes close to the upper or lower end of the display screen of the display unit 117, the gain value decreases and becomes √1.1 at a vertical position at the upper or lower end.

In a subframe image gain value distribution 212, the gain value becomes larger for a vertical position closer to the upper or lower end of the display screen of the display unit 117. The gain value becomes smaller for a vertical position closer to the center of the display screen of the display unit 117. In FIG. 2B, the gain value for a vertical position at the center of the display screen of the display unit 117 is √0.8. As the vertical position comes close to the upper or lower end of the display screen of the display unit 117, the gain value increases and becomes √0.9 at a vertical position at the upper or lower end. Since the number of vertical pixels is 1,080, the coefficient unit 111 holds 1,080 coefficients×two frames=2,160 coefficients. At all vertical positions, the sum of the frame image gain value and subframe image gain value is always constant (=1.0).

That is, according to the first embodiment, a smaller frame image gain value is assigned to a pixel position closer to the periphery of the display screen, and a larger frame image gain value is assigned to a pixel position (coordinate position) closer to the center of the display screen. Further, a larger subframe image gain value is assigned to a pixel position closer to the periphery of the display screen, and a smaller subframe image gain value is assigned to a pixel position closer to the center of the display screen. The coefficient units 109 and 111 hold these assigned gain values, as described above.

With this arrangement, each of the gains of frame and subframe images output from the multiplier 115 is given by the sum of gains at vertical and horizontal positions. When an image signal having a uniform luminance value on the entire display screen of the display unit 117 is input, the luminance value becomes large at the center of the display screen of the display unit 117 and small at the periphery for the frame image. For the subframe image, the luminance value becomes small at the center of the display screen of the display unit 117 and large at the periphery. For example, in FIGS. 2A to 2D, the average gain of the frame and subframe images is 1.0, and the average gains at pixel positions (e) to (m) on the display screen of the display unit 117 are also 1.0. In FIGS. 2C and 2D, the gain ratio at the center of the display screen of the display unit 117 is 1.2:0.8 (1.5:1). The gain ratio is 1.15:0.85 (1.35:1) at the pixel positions (f), (h), (j), and (1), and 1.1:0.9 (1.2:1) at pixel positions (e), (g), (k), and (m). More specifically, upon receiving a signal having a uniform luminance on the entire display screen of the display unit 117, the luminance value difference between the frame and subframe images becomes small at the periphery and large at the center. Further, the average luminance value of the frame and subframe images is constant regardless of the pixel position in the display screen of the display unit 117.

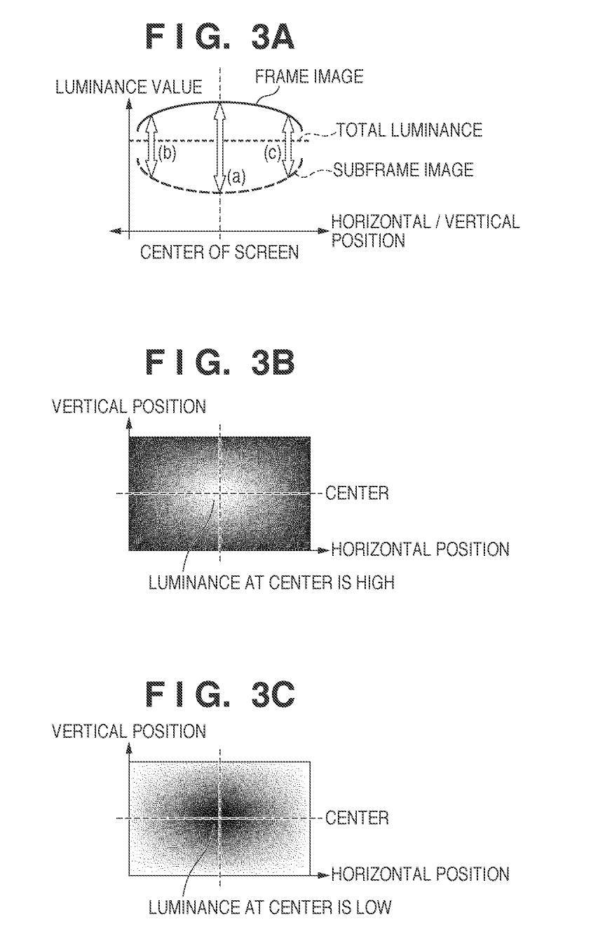

The frame and subframe images of an image signal having a luminance value of 300 cd/m² on the entire display screen have a distribution as shown in FIG. 3A. For descriptive convenience, assume that both the frame and subframe images are displayed on the display screen of the display unit 117 so that their center positions coincide with that of the display screen of the display unit 117.

In FIG. 3A, the abscissa axis indicates a vertical/horizontal position in the display screen of the display unit 117, and the ordinate axis indicates a luminance value. As shown in FIGS. 3A and 3B, for the frame image, the luminance value becomes larger for a vertical/horizontal position closer to the center of the screen (center of the image), and smaller for a vertical/horizontal position closer to the periphery of the screen. As shown in FIGS. 3A and 3C, for the subframe image, the luminance value becomes smaller for a vertical/horizontal position closer to the center of the screen, and larger for a vertical/horizontal position closer to the periphery of the screen.

Assuming that the display apparatus is viewed at a distance of 3 H (H is the height of the display apparatus), the horizontal visual angle is about 30° or less. In this visual angle range, flickering can be suppressed by setting a small luminance value difference between the frame and subframe images at the periphery of the screen, and a large luminance value at the center.

Perception of flickering is also related to the brightness of the screen. When the luminance value is about 300 cd/m², the luminance value difference between the frame and subframe images is set to 1.2:1 at the periphery and 1.5:1 at the center. Although perception of flickering differs between individuals, when the average luminance value is as high as about 300 cd/m², flickering at the center and periphery of the screen can be suppressed by setting the above-mentioned differences.

In FIG. 3A, for the frame image, the luminance value at the center of the image is set to 180 cd/m², which is higher than a luminance value of 165 cd/m² at the periphery. For the subframe image, the luminance value at the periphery is set to 135 cd/m², which is higher than a luminance value of 120 cd/m² at the center of the image.

In FIG. 3A, the luminance value at the periphery of the subframe image is smaller than that at the periphery of the frame image. In FIG. 3A, the average (total luminance) of the luminance values of the frame and subframe images is equal (300 cd/m²) between the center and periphery of the image.

As shown in FIG. 3A, a luminance value difference (a) at the center of the image is larger than luminance value differences (b) and (c) at the periphery in the frame and subframe images.

In this way, luminance value differences at the center and periphery of the screen are set as described above, and frame and subframe images are alternately displayed, obtaining the following effects. That is, while the average luminance value sensed by the observer's eye keeps constant, the luminance value difference at the periphery where flickering increases can be decreased, and that at the center almost free from the influence of flickering can be increased.

For the subframe image, blurring of a moving image at the center of the screen can be reduced by decreasing the luminance value for a position closer to the center of the screen. Even if a subframe image is erroneously generated, it can be made less conspicuous.

In the first embodiment, an image is displayed on the entire screen at an average luminance value of 300 cd/m², but flickering changes depending on even the absolute luminance. If the screen luminance is very low, flickering is hardly sensed, and thus the luminance value difference between the frame and subframe images can be set large at both the center and periphery of the screen.

In the first embodiment, the coefficient unit 109 stores gain values corresponding to horizontal positions. However, the coefficient unit 109 may store data (or programs) of the distribution functions of the frame image gain value and subframe image gain value corresponding to the horizontal position, as shown in FIG. 2A.

Similarly, in the first embodiment, the coefficient unit 111 stores gain values corresponding to vertical positions. However, the coefficient unit 111 may store data (or programs) of the distribution functions of the frame image gain value and subframe image gain value corresponding to the vertical position, as shown in FIG. 2B.

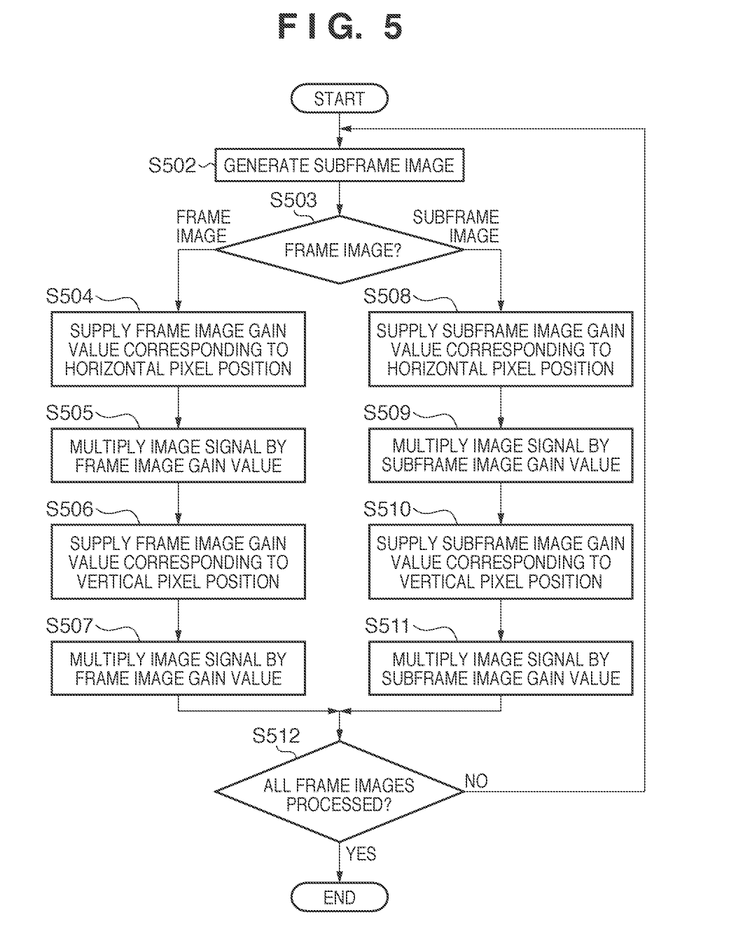

Processing performed by the image display apparatus according to the first embodiment will be described with reference to the flowchart of FIG. 5. Note that this processing has already been described above and will be explained briefly here.

In step S502, the speed doubling circuit 103 generates the subframe image g from the frame image f input via the input terminal 101 and the frame image (f−1) which has already been stored in the memory 105. The speed doubling circuit 103 sequentially sends the frame image f and generated subframe image g to the subsequent multiplier 113.

If the controller 107 controls the speed doubling circuit 103 to output the frame image f, the process advances to step S504 after step S503. If the controller 107 controls the speed doubling circuit 103 to output the subframe image g, the process advances to step S508 after step S503.

In step S504, the coefficient unit 109 supplies, to the multiplier 113, a frame image gain value corresponding to a horizontal position designated by the controller 107. In step S505, the multiplier 113 multiplies the image signal of a pixel at each horizontal position of the frame image f by a gain value supplied from the coefficient unit 109 for each horizontal position, generating the frame image f′. The multiplier 113 sends the frame image f′ to the subsequent multiplier 115.

In step S506, the coefficient unit 111 supplies, to the multiplier 115, a frame image gain value corresponding to a vertical position designated by the controller 107. In step S507, the multiplier 115 multiplies the image signal of a pixel at each vertical position of the frame image f′ by a gain value supplied from the coefficient unit 111 for each vertical position, generating the frame image f″. The multiplier 115 sends the frame image f″ as a display frame image to the subsequent display unit 117.

In step S508, the coefficient unit 109 supplies, to the multiplier 113, a subframe image gain value corresponding to a horizontal position designated by the controller 107. In step S509, the multiplier 113 multiplies the image signal of a pixel at each horizontal position of the subframe image g by a gain value supplied from the coefficient unit 109 for each horizontal position, generating the subframe image g′. The multiplier 113 sends the subframe image g′ to the subsequent multiplier 115.

In step S510, the coefficient unit 111 supplies, to the multiplier 115, a subframe image gain value corresponding to a vertical position designated by the controller 107. In step S511, the multiplier 115 multiplies the image signal of a pixel at each vertical position of the subframe image g′ by a gain value supplied from the coefficient unit 111 for each vertical position, generating the subframe image g″. The multiplier 115 sends the generated subframe image g″ as a display subframe image to the subsequent display unit 117.

If this processing has been executed for all frame images, the process ends after step S512. If this processing has not been executed for all frame images, the process returns to step S502 after step S512 to perform the processes in step S502 and subsequent steps for the next frame image.

### Second Embodiment

In the second embodiment, when an image signal having a uniform luminance value on the entire image is input via an input terminal 101, the luminance value is set larger for a pixel position closer to the center of the screen and smaller for a pixel position closer to the periphery for a frame image, similar to the first embodiment. However, for a subframe image, the luminance value is updated to a constant value smaller than the minimum luminance value of the luminance value-changed frame image (display frame image) regardless of whether the pixel position is close to the center or periphery of the screen. In other words, the second embodiment is different from the first embodiment only in adjustment of the luminance value for a subframe image, and the remaining processing is the same as that in the first embodiment. Similar to the first embodiment, multipliers 113 and 115 adjust the luminance value.

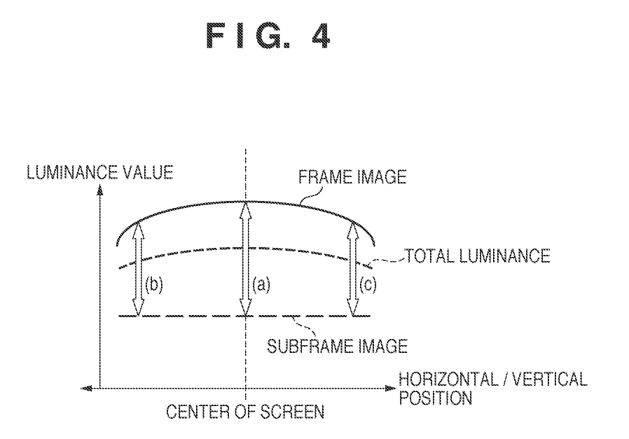

The second embodiment will be explained with reference to FIG. 4. FIG. 4 shows the distribution of luminance values at vertical and horizontal positions for each of a frame image in which the luminance value becomes larger for a pixel position closer to the center of the screen and smaller for a pixel position closer to the periphery, and a subframe image in which the luminance value is constant regardless of whether the pixel position is close to the center or periphery of the screen. FIG. 4 also shows the total luminance of the luminance values of the frame and subframe images at each position. The total luminance exhibits a larger value for a pixel position closer to the center of the screen. The luminance value at the periphery in the subframe image is smaller than the luminance value (minimum luminance value in a display frame image) at the periphery in the frame image. For descriptive convenience, assume that both the frame and subframe images are displayed on the display screen of a display unit 117 so that their center positions coincide with that of the display screen of the display unit 117. As shown in FIG. 4, a luminance value difference (a) at the center of the image is larger than luminance value differences (b) and (c) at the periphery in the frame and subframe images.

In this fashion, according to the second embodiment, the luminance value is set larger for a pixel position closer to the center of a frame image and smaller for a pixel position closer to the pixel position. For a subframe image, the luminance value is set constant (constant value smaller than the minimum luminance value in the frame image) regardless of whether the pixel position is close to the center or periphery of the image. As a result, the luminance value difference at the periphery where flickering increases can be decreased, and that at the center of the image almost free from the influence of flickering can be increased.

By decreasing the luminance value of a subframe image, the problem in which a moving image looks blurred at the center of the image can be improved. Even if a subframe image is erroneously generated, it can be made less conspicuous.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-278947 filed Dec. 8, 2009 which is hereby incorporated by reference herein in its entirety.

What is claimed is:

1. An image display apparatus, comprising:
an input unit which sequentially inputs frame images that form a moving image;
a subframe image generation unit which generates a subframe image to be displayed at timing between display timings of two adjacent frame images;
a display frame image generation unit which generates a display frame image, in which a pixel being at a pixel position closer to a periphery of the frame image has smaller luminance value than that of a pixel being at a center of the frame image;
a display subframe image generation unit which generates a display subframe image, in which a pixel being at a pixel position closer to a periphery of the frame image has larger luminance value than that of a pixel being at a center of the frame image; and
an output unit which sequentially outputs the display frame image and the display subframe image.

2. The apparatus according to claim 1, wherein a smaller frame image gain value is assigned to a pixel position closer to a periphery of the frame image, and a larger frame image gain value is assigned to a pixel position closer to a center of the frame image,
said display frame image generation unit multiplies an image signal of each pixel which forms the frame image, by the frame image gain value assigned to a coordinate position of the pixel on the frame image, thereby generating the display frame image in which a pixel being at a pixel position closer to a periphery of the frame image has smaller luminance value and a pixel being at a pixel position closer to a center of the frame image has larger luminance value.

3. The apparatus according to claim 1, wherein a larger subframe image gain value is assigned to a pixel position closer to a periphery of the subframe image, and a smaller subframe image gain value is assigned to a pixel position closer to a center of the subframe image, and
said display subframe image generation unit multiplies an image signal of each pixel which forms the subframe image, by the subframe image gain value assigned to a coordinate position of the pixel on the subframe image, thereby generating the display subframe image in which a pixel being at a pixel position closer to a periphery of the subframe image has larger luminance value and a pixel being at a pixel position closer to a center of the subframe image has smaller luminance value.

4. The apparatus according to claim 1, wherein
said display subframe image generation unit generates the display subframe image in which a luminance value of each pixel that forms the subframe image is updated to a constant value smaller than a minimum luminance value in the display frame image.

5. The apparatus according to claim 1, wherein a sum of gain values by which image signals at the same pixel position in the frame image and the subframe image are multiplied is constant regardless of the pixel position.

6. An image display method performed by an image display apparatus having a display screen for displaying a moving image, comprising:
an input step of sequentially inputting frame images that form the moving image;
a subframe image generation step of generating a subframe image to be displayed at timing between display timings of two adjacent frame images;
a display frame image generation step of generating a display frame image, in which a pixel being at a pixel position closer to a periphery of the frame image has smaller luminance value than that of a pixel being at a center of the frame image;
a display subframe image generation step of generating a display subframe image, in which a pixel being at a pixel position closer to a periphery of the frame image has larger luminance value than that of a pixel being at a center of the frame image; and
an output step of sequentially outputting the display frame image and the display subframe image.

7. The method according to claim 6, wherein a smaller frame image gain value is assigned to a pixel position closer to a periphery of the frame image, and a larger frame image gain value is assigned to a pixel position closer to a center of the frame image,
the display frame image generation step includes a step of multiplying an image signal of each pixel which forms the frame image, by the frame image gain value assigned to a coordinate position of the pixel on the frame image, thereby generating the display frame image in which a pixel being at a pixel position closer to a periphery of the frame image has smaller luminance value and a pixel being at a pixel position closer to a center of the frame image has larger luminance value.

8. The method according to claim 6, wherein a larger subframe image gain value is assigned to a pixel position closer to a periphery of the subframe image, and a smaller subframe image gain value is assigned to a pixel position closer to a center of the subframe image, and
the display subframe image generation step includes a step of multiplying an image signal of each pixel which forms the subframe image, by the subframe image gain value assigned to a coordinate position of the pixel on the subframe image, thereby generating the display subframe image in which a pixel being at a pixel position closer to a periphery of the subframe image has larger luminance value and a pixel being at a pixel position closer to a center of the subframe image has smaller luminance value.

9. The method according to claim 6, wherein
the display subframe image generation step includes a step of generating the display subframe image in which a luminance value of each pixel that forms the subframe image is updated to a constant value smaller than a minimum luminance value in the display frame image.

10. The method according to claim 6, wherein a sum of gain values by which image signals at the same pixel position in the frame image and the subframe image are multiplied is constant regardless of the pixel position.

11. A non-transitory computer-readable storage medium storing a computer program for causing a computer to function as units of an image display apparatus defined in claim 1.
